(19) United States
(12) Patent Application Publication
(10) Pub. No.: US 2019/0010262 A1
(43) Pub. Date: Jan. 10, 2019

(54) ETHYLENE BASED POLYMER COMPOSITION SUITABLE FOR USE IN EXTRUSION COATING

(71) Applicant: SABIC GLOBAL TECHNOLOGIES B.V., Bergen op Zoom (NL)

(72) Inventors: Fan Ling, Geleen (NL); Zaichuan Hou, Geleen (NL); Kun Jiang, Geleen (NL); Franciscus Petrus Hermanus Schreurs, Maastricht (NL); Qiang Wang, Geleen (NL)

(21) Appl. No.: 16/067,255

(22) PCT Filed: Dec. 7, 2016
(86) PCT No.: PCT/CN2016/108796

§ 371 Date: Jun. 29, 2018

(30) Foreign Application Priority Data
Dec. 31, 2015 (CN) 201511028755.3

(51) Int. Cl. C08F 210/02; C08F 210/08; C08F 210/14; C08F 236/20; C09D 123/08

(52) U.S. Cl. CPC C08F 210/02; C08F 210/08; C08F 210/14; C08F 2800/20; C09D 123/08; C08F 2500/08; C08F 2500/12; C08F 236/20

(57) ABSTRACT

The present invention relates to an ethylene based polymer composition suitable for use in extrusion coating. The present invention also relates to an extrusion coating product comprising such composition and the use of such a composition.

The present invention relates to an ethylene based polymer composition suitable for use in extrusion coating. The present invention also relates to an extrusion coated article comprising such composition and the use of such a composition.

Polyolefins, especially polyethylene, is/are routinely used in extrusion coating.

Extrusion coating is the coating of a molten polymer onto a substrate material, like for example paperboard, paper, aluminum foils, non-wovens, plastic films, corrugated fiberboard or cellulose, polymer fibers, tarpaulin.

During the extrusion coating process a polymer and a substrate are thus combined to form products with specific synergetic characteristics. The increasing processing and product requirements and quality demands may result in several different problems that can occur in the extrusion coating process.

Rheology-related phenomena, such as for example web stability, neck-in and draw-down may thereby cause problems in extrusion coating.

The web stability may be a problem especially during the cooling of the polymer melt, since several competing forces combine and make the cooling process quite complicated. The cooling may lead to a break-up of the layer of molten polymer or the molten polymer “web”.

Neck-in may be the reduction width of the coating. It can lead to uncoated areas on a substrate.

Draw-down is the ability of a polymer melt to be drawn to thin coatings from the thickness of the die gap to the thickness of the coating, preferably without breaking, by being pulled away by the substrate it is applied on.

In extrusion coating, the thin molten polymer film is coated on the substrate.

At high extrusion coating speed, even a minor disturbance in the melt may cause major quality problems that can very rapidly lead to large quantities of waste. Therefore polymers are required with high and consistent quality to avoid waste due to polymer web break and neck-in phenomena.

Moreover, polymer with very good draw down properties are preferred at high extrusion coating speeds.

Today LDPE produced by using high-pressure autoclave technology may be used in extrusion coating applications. LDPE obtained with an autoclave process is usually suitable to be applied in extrusion coating.

However, for very high extrusion coating speeds for example between 200 m/min and 275 m/min, LDPE may not be suitable anymore as draw down properties may not be good enough and web break phenomena may appear. Moreover, for LDPE viscosity may be quite high, which may lead to a high coating weight.

It is thus the object of the present invention to provide an ethylene based polymer composition suitable in extrusion coating which may have or allow enhanced the web stability and/or reduced neck-in and/or improved draw-down properties and/or reduced viscosity and/or a reduced coating weight, especially at very high extrusion coating speed during the extrusion coating process while obtaining also the other desired properties.

It is an objective of the present invention to provide an ethylene based polymer composition suitable for use suitable in extrusion coating in which above-mentioned problems are solved.

Accordingly, the invention provides an ethylene based polymer composition for extrusion coating comprising or consisting of:

a) 51-95 wt % of polymer A comprising or consisting of at least 60 wt % of ethylene based on the weight of polymer A and

b) 5-49 wt % of a polymer B comprising or consisting of at least 60 wt % of ethylene based on the weight of polymer B and between 0.01 and 5 wt % of a compound comprising at least two a (meth)acrylate functions based on the weight of the polymer B, the weight percentages of a) and b) being based on the weight of the ethylene based polymer composition.

An ethylene based polymer composition according to the present invention may especially be suitable for extrusion coating, especially on a substrate, like for example paperboard, paper, aluminum foils, non-wovens, plastic films, corrugated fiberboard or cellulose.

It is an advantage of the invention that the composition according to the invention can be used for extrusion coating, especially at high and/or very high extrusion coating speed, while reducing web break and/or neck-in phenomena and/or with good draw down properties.

Polymer A may be a copolymer of ethylene and at least one other alpha-olefin, as comonomer, especially for example propylene, butene, hexene or octene.

Polymer A may comprise ethylene and at least one alpha-olefin, as comonomer. Preferably polymer A may consist of ethylene and at least one alpha-olefin, as comonomer, preferably exactly one alpha-olefin, as comonomer.

Polymer A may comprise or consist of for example at least 60 wt %, preferably at least 85 wt %, further preferred at least 87 wt %,further preferred at least 88 wt %, further preferred at least 90 wt %, alternatively at least 91 wt %, alternatively at least 95 wt %, of ethylene based on the weight of polymer A.

Polymer A may have a comonomer content of between 0.01 and 40 wt %, preferably between 0.1 and 15 wt %, preferably between 1 and 12 wt %, preferably between 3 and 10 wt %, based on the weight of polymer A.

Polymer A may especially for example be an linear low density polyethylene(LLDPE), especially an LLDPE comprising or consisting of ethylene and 1-hexene or 1-butene, as comonomer, further preferred an LLDPE with an comonomer content of between 0.01 and 40 wt %, preferably between 0.1 and 15 wt %, preferably between 1 and 13 wt %, preferably between 3 and 12 wt %, based on the weight of the LLDPE.

Linear low-density polyethylenes (LLDPE) may for example be obtained by polymerizing ethylene as monomer, optionally in the presence of one or more comonomers. For example, such comonomers may include 1-butene, 1-pentene, 4-methyl-1-pentene, 1-hexene, 1-heptene and/or 1-octene.

For example, such comonomers may be present in quantities of ≤40.0% by weight, alternatively ≤30.0% by weight, alternatively ≤15.0% by weight, alternatively ≤10.0% by weight, alternatively ≤5.0% by weight, alternatively ≤3.0% by weight, compared to the total weight of the low-density polyethylene.

For example, such comonomers may be present in quantities of ≥0.05% by weight, alternatively ≥0.10% by weight, alternatively ≥0.30% by weight, alternatively ≥0.50% by weight, alternatively ≥1.00% by weight, compared to the total weight of the low-density polyethylene.

For example, such comonomers may be present in quantities of ≥0.05% and ≤40.0 by weight, alternatively ≥0.10% and ≤10.0% by weight, alternatively ≥0.30% and ≤3.0% by weight, compared to the total weight of the low-density polyethylene.

Polymer A may especially for example have a density determined according to ISO 1183-1 (2012), method A for example between 0.915 and 0.935 g/cm³, preferably between 0.920 and 0.930 g/cm³, and/or MFI represented by the melt mass flow rate as measured according to ISO 1131-1 (2011) at 190° C. and under a load of 2.16 kg between 5 and 40, preferably between 10 and 30, further preferred between 15 and 25.

The ethylene based polymer composition according to the invention may comprise or consist of 51-95 wt %, preferably 65-95 wt %, preferably 70-90 wt %, further preferred 75 to 85 wt % of polymer A and/or 5-49 wt %, preferably 5-35 wt %, preferably 10-30 wt %, further preferred 15-25 wt % of polymer B.

Polymer B may especially for example be an LDPE, especially an at least partially cross-linked LDPE, obtained for example by free radical polymerization and/or a high pressure process.

Polymer B may comprise or consist of for example at least 60 wt %, preferably at least 85 wt %, further preferred at least 90 wt %, alternatively at least 92 wt %, alternatively at least 95 wt %, alternatively at least 98 wt %, alternatively between 98 and 99.95 wt %, alternatively between 99.5 and 99.9 wt %, of ethylene based on the weight of polymer B.

Polymer B may thereby have a density determined according to ISO 1183-1 (2012), method A for example between 0.905 and 0.935 g/cm³, preferably 0.910 and 0.930 g/cm³ and/or MFI represented by the melt mass flow rate as measured according to ISO 1131-1 (2011) at 190° C. and under a load of 2.16 kg between 1 and 10, preferably between 2.5 and 7.5.

Polymer B may further comprise compound comprising at least two a (meth)acrylate functions. Polymer B may preferably consist of ethylene and at least one compound comprising at least two a (meth)acrylate functions. Comprising at least two a (meth)acrylate functions may thereby mean for example comprising at least two acrylate or at least two methacrylate functions or at least one acrylate and one methacrylate function

Polymer B may comprise for example between 0.01 and 5 wt %, preferably between 0.05 and 2 wt %, further preferred between 0.07 and 1 wt %, further preferred between 0.1 and 0.5 wt % of a compound comprising at least two a (meth)acrylate functions. Such a compound may for example be especially a diacrylate or a dimethacrylate, further preferred ButaneDiolDiMethAcrylate(BDDMA).

Polymer B may thus be at least partially cross-linked by the compound comprising at least two a (meth)acrylate functions.

The ethylene based polymer composition may especially comprise or consist of a compound or a dry blend of the polymers A and B.

Accordingly, the invention provides an ethylene based polymer composition for extrusion coating comprising or consisting of a dry blend of:

a) 51-95 wt % of polymer A, which is an LLDPE comprising or consisting of at least 60 wt % of ethylene based on the weight of polymer A and

b) 5-49 wt % of a polymer B which is an LDPE comprising or consisting of at least 60 wt % of ethylene based on the weight of polymer B and between 0.01 and 5 wt % of BDDMA based on the weight of the polymer B, the weight percentages of a) and b) being based on the weight of the ethylene based polymer composition.

The invention provides an ethylene based polymer composition for extrusion coating comprising or consisting of a dry blend of:

a) 70-90 wt % of polymer A, which is an LLDPE, with a density between 0.915 and 0.935 g/cm³ and/or a melt flow rate between 5 and 40, comprising or consisting of at least 90 wt % of ethylene based on the weight of polymer A and

b) 10-30 wt % of a polymer B which is an LDPE, with a density between 0.905 and 0.935 g/cm³ and/or a melt flow rate between 1 and 10, comprising or consisting of between 99.9 wt % and 99.5 wt % of ethylene based on the weight of polymer B and between 0.1 and 0.5 wt % of BDDMA based on the weight of the polymer B, the weight percentages of a) and b) being based on the weight of the ethylene based polymer composition.

The present invention also concerns an extrusion coating product comprising or consisting of an ethylene based polymer composition according to the invention and a substrate, especially for example on paperboard, paper, aluminum foils, non-wovens, plastic films, corrugated fiberboard or cellulose, polymer fibers, tarpaulin.

The present invention also concerns the use of an ethylene based polymer composition according to the invention in an extrusion coating process, especially for example on paperboard, paper, aluminum foils, non-wovens, plastic films, corrugated fiberboard or cellulose, polymer fibers, tarpaulin.

1. Ethylene based polymer composition comprising of:
a) 51-95 wt % of polymer A comprising of at least 60 wt % of ethylene based on the weight of polymer A; and
b) 5-49 wt % of a polymer B comprising at least 60 wt % of ethylene based on the weight of polymer B and between 0.01 and 5 wt % of a compound comprising at least two a (meth)acrylate functions based on the weight of the polymer B, the weight percentages of a) and b) being based on the weight of the ethylene based polymer composition.

2. Ethylene based polymer composition according to claim 1, whereby polymer A is an LLDPE and/or comprises 1-hexene or 1-butene as comonomer.

3. Ethylene based polymer composition according to claim 1, whereby polymer A has a density between 0.915 and 0.935 g/cm³ and/or a melt flow rate between 5 and 40.

4. Ethylene based polymer composition according to claim 1, whereby the ethylene based polymer composition comprises 70-90 wt %, of polymer A and/or 10-30 wt % of polymer B based on the weight of the ethylene based polymer composition.

5. Ethylene based polymer composition according to claim 1, whereby polymer B is an LDPE.

6. Ethylene based polymer composition according to claim 1, whereby polymer B has a density between 0.905 and 0.935 g/cm³ and/or a melt flow rate between 1 and 10.

7. Ethylene based polymer composition according to claim 1, whereby polymer B comprise BDDMA as a monomer.

8. (canceled)

9. Ethylene based polymer composition according to claim 1, whereby the ethylene based polymer composition comprises a dry blend or a compound of the polymers A and B.

10. An extrusion coating product comprising an ethylene based polymer composition according to claim 1 and a substrate.

11. (canceled)

12. Ethylene based polymer composition according to claim 1, whereby the ethylene based polymer composition consists of 70-90 wt % of polymer A and 10-30 wt % of polymer B based on the weight of the ethylene based polymer composition.

13. Ethylene based polymer composition according to claim 12, whereby the ethylene based polymer composition consists of 75 to 85 wt % of polymer A and 15-25 wt % of polymer B based on the weight of the ethylene based polymer composition.

14. Ethylene based polymer composition according to claim 1, whereby polymer A has a density between 0.915 and 0.935 g/cm³ and/or a melt flow rate between 5 and 40;
whereby the ethylene based polymer composition comprises 70-90 wt % of polymer A and/or 10-30 wt % of polymer B based on the weight of the ethylene based polymer composition; and
whereby polymer B has a density between 0.905 and 0.935 g/cm³ and/or a melt flow rate between 1 and 10.

15. Ethylene based polymer composition according to claim 14, whereby the ethylene based polymer composition consists of 70-90 wt % of polymer A and 10-30 wt % of polymer B based on the weight of the ethylene based polymer composition.
